(19) United States
(12) Patent Application Publication
(10) Pub. No.: US 2016/0039194 A1
(43) Pub. Date: Feb. 11, 2016

(54) ADDITIVE MANUFACTURING USING MISCIBLE MATERIALS

(71) Applicant: Eastman Chemical Company, Kingsport, TN (US)

(72) Inventor: Kevin Michael Cable, Kingsport, TN (US)

(73) Assignee: EASTMAN CHEMICAL COMPANY, Kingsport, TN (US)

(21) Appl. No.: 14/454,796

(22) Filed: Aug. 8, 2014

(51) Int. Cl. B32B 38/00

(52) U.S. Cl. CPC B32B 38/0004; B33Y 10/00

(57) ABSTRACT

An object can be formed in an additive manufacturing process, such as FDM, by providing a substrate having at least a surface that is made of a first material, and forming one or more layers of a second material on the surface of the substrate, wherein a Hildebrand solubility parameter of the second material is within about 5% of a Hildebrand solubility parameter of the first material. In this manner, the object part formed by the one or more layers of the second material may be incorporated into the object. In an example, the object includes a first portion comprised of the one or more layers of the second material and a second portion comprised of the substrate, the first portion having a first haze value and the second portion having a second haze value, wherein a percent difference between the first haze value and the second haze value is equal to or greater than about 165%.

### BACKGROUND

Additive manufacturing is a process used to produce three-dimensional (3D) objects. Additive manufacturing can be performed by extruding a flowable material through a nozzle of an extrusion head and depositing (typically layer-by-layer) the material onto a platform to form the 3D object thereon. In some instances, the material used to form the layers of the 3D object may be referred to herein as “build material.” Extrusion-based additive manufacturing is sometimes called “fused deposition Modeling®” (FDM®), which is a trademark of Stratasys Ltd. Of Edina, Minn., “fused filament fabrication” (FFF), or more generally, “3D printing.” A 3D object can be digitally represented in 3D object data (e.g., a computer-aided design (CAD) model), which can be processed by an additive manufacturing system (e.g., a 3D printer) to form the 3D object using the additive manufacturing process. Particularly, the digital representation of the 3D object can be mathematically sliced into multiple horizontal layers. The additive manufacturing system can then generate a build path for each layer and use computer-control to move an extrusion head having a nozzle along the build path for each layer to deposit fluent strands or “roads” of the build material in a layer-by-layer manner onto a platform or a build substrate. For example, the additive manufacturing system can move an extrusion head/nozzle, the platform/build substrate, or both the nozzle and platform vertically and horizontally relative to each other to form the 3D object. The build material from which the 3D object is formed hardens shortly after extrusion to form a solid 3D object.

Common build materials used in extrusion-based additive manufacturing systems include polylactic acid (PLA) and acrylonitrile butadiene styrene (ABS), among others, which are typically supplied from filament spools to a hot end of the extrusion head where the filament is melted to a semi-liquid, flowable state and forced or extruded through the nozzle onto the platform. The substrate on which the build material is deposited is typically made of metal or plastic to provide adequate adhesion of the build material to the substrate. The adequate adhesion characteristics can minimize movement of the object during the formation of the object on one hand, and also allow the object to be easily removable after formation of the object on the other hand so that the substrate can be re-used for producing a subsequent 3D object thereon. However, adhesion strength above a certain level between the substrate and the build material can cause damage to the 3D object upon attempting to remove the 3D object from the substrate after forming the 3D object on the substrate. To this end, a variety of substrate surfacing materials have been developed to facilitate separation of the 3D object from the substrate after printing, those materials including painter's tape, glass, garolite, fiberglass, among others. However, configuring an additive manufacturing system with the desired adhesion characteristics at the substrate-object interface is complex and sometimes difficult to achieve in practice.

### SUMMARY

This summary is provided to introduce a selection of concepts for forming an object using additive manufacturing. Additional details of example techniques, systems, and materials are further described below in the Detailed Description. This summary is not intended to identify key features or essential features of the claimed subject matter, nor is it intended for use in determining the scope of the claimed subject matter

An object can be formed by providing a substrate having at least a surface that includes a first material, and forming one or more layers of a second material on the surface of the substrate. The second material can have a Hildebrand solubility parameter that is within about 5% of a Hildebrand solubility parameter of the second material. Additionally, an object can be produced that includes a section of the substrate and the one or more layers of the second material. In some cases, a section of the substrate can be removed from a remainder of the substrate.

An object can also be produced by forming one or more layers of a material on a portion of a surface of a substrate according to a pattern. The object can have a first portion comprised of the one or more layers of the material and a second portion comprised of at least a section of the substrate. The first portion can have a first haze value and the second portion can have a second haze value, wherein a percent difference between the first haze value and the second haze value is equal to or greater than about 165%.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates example components of a first example additive manufacturing system.

FIG. 2 illustrates example components of a second example additive manufacturing system.

FIG. 3 illustrates a close-up, side view of a first layer of an example object part being deposited onto an example substrate during an additive manufacturing process.

FIG. 4 illustrates a close-up, side view of multiple layers of an example object part being deposited during an additive manufacturing process.

FIG. 5 illustrates a partial perspective view of example components of an example additive manufacturing system showing a portion of the substrate that is to be incorporated into a completed object and a portion of the substrate that is to be removed for completing the object.

FIG. 6 illustrates a top view along section line A-A of FIG. 5 showing a portion of the substrate that is to be incorporated into a completed object and a portion of the substrate that is to be removed for completing the object.

FIG. 7 illustrates a top view of an example substrate having a plurality of portions to be incorporated into objects formed by an additive manufacturing process.

FIG. 8 is a flow diagram of an illustrative process of forming a 3D object using an additive manufacturing system.

FIG. 9 shows a first object part that was formed on a first substrate and a second object part that was formed on a second substrate using an additive manufacturing system.

FIG. 10 shows the first object part and the second object part of FIG. 9 after applying respective forces to separate the first object part from the first substrate and the second object part from the second substrate.

FIG. 11 shows a first hexagonal vase formed using an additive manufacturing process, a second, shorter hexagonal vase formed using the additive manufacturing process, a third hexagonal vase that was formed on a first substrate, and a fourth hexagonal vase that was formed on a second substrate, but without a bottom to the hexagonal vase.

FIG. 12 shows the second hexagonal vase of FIG. 11 next to a completed object comprising the fourth hexagonal vase and a portion of the second substrate of FIG. 11.

FIG. 13 shows an object part that was formed on a substrate, and a completed object comprised of the object part and a portion of the substrate, wherein the completed object is shown coupled to a board.

FIG. 14 shows an object part formed on a substrate comprised of a board that was coated with a material that is miscible with the build material of the object part.

### DETAILED DESCRIPTION

Embodiments of the present disclosure are directed to, among other things, techniques, systems, and materials for forming an object using an additive manufacturing system. An additive manufacturing process is the process of joining materials to make objects from digital 3D design data. Desirably, the additive manufacturing process used in the invention joins materials layer upon layer. One of the additive manufacturing processes useful in the invention is fused deposition modeling (FDM).

A first material can be provided on at least a surface of a substrate, and one or more layers of a second material can be formed on the substrate to produce a portion of the object on the surface of the substrate. In this way, the portion of the object can be attached to the substrate for incorporating at least a portion of the substrate into the object.

It is to be appreciated that the object formed using the techniques, systems, and materials disclosed herein can be intended for any suitable application including, without limitation, modeling, rapid prototyping, production, and the like. The system used to create the object can be implemented in any suitable context including end-consumer systems, prosumer systems, or professional-grade additive manufacturing systems. For example, additive manufacturing systems such as extrusion-based 3D printers or FDM) and materials for implementing the techniques disclosed herein can be manufactured and sold to consumers for at-home building of 3D objects (e.g., “do-it-yourself” 3D printing kits, desktop 3D printers, and the like). Additionally, or alternatively, companies of any size can utilize the techniques disclosed herein by implementing additive manufacturing systems at their facilities to mass manufacture 3D objects with high throughput so that the 3D objects/products can be sold in the open market. Industries that can benefit from the techniques, systems, and materials disclosed herein include, without limitation, cosmetics (e.g., cosmetic container manufacturing), beverage container manufacturing, packaging, and so on.

Miscible thermoplastic polymers can be utilized for at least a portion of each of the substrate and the build material to promote a firm attachment or bond at the interface between the portions of a completed object. In this sense, a first thermoplastic polymer of the substrate is considered to be a “like”-thermoplastic polymer to that of a second thermoplastic polymer used for forming the 3D printed portion of the 3D object. The firm attachment created by the use of miscible thermoplastic polymers can be counterintuitive in the context of traditional extrusion-based additive manufacturing systems where the objective is to facilitate separation of a 3D printed object and the substrate on which the 3D printed object is formed. However, since at least a portion of the substrate is to be incorporated into (i.e., become part of) the completed 3D object as described herein, the firm attachment/bond provided by the miscible thermoplastic polymers is beneficial. That is, the portion of the substrate to be incorporated into the completed 3D object is prevented from being separated from the 3D printed portion of the 3D object after printing by the firm attachment at the interface therebetween.

The strength of the bond at the interface between the preformed substrate and the 3D printed portion is at a level that, upon the 3D printed portion being subjected to a shear force of an amount to cause failure (part separation or cleavage), the failure occurs at a location other than the interface. The shear force is an unaligned force pushing one part of a body in one direction, and another part of the body in the opposite or stationary direction. In this case, the shear force can be an applied force to the 3D printed object part in a direction perpendicular to the object part while the object part is attached to the substrate and while holding the substrate stationary, with a force sufficient to cause the object part to separate from the substrate. The bond at the interface of the 3D object part and the substrate is sufficiently strong that at least about 60%, or at least about 70%, or at least about 80%, or at least about 85%, or at least about 90%, or at least about 95%, or at least about 97%, or at least about 99%, or about 100% of the interface surface area remains bonded.

Furthermore, the techniques and systems disclosed herein allow for the additive manufacturing of objects having functional and/or decorative characteristics that have heretofore been unachievable using any conventional manufacturing technology alone. For example, extrusion-based additive manufacturing systems have heretofore been unable to produce transparent features of objects. Moreover, extrusion (i.e., advancing material through a die) and injection-molding manufacturing, among other known manufacturing processes, cannot easily form the complex geometries and shapes that are facilitated by the additive manufacturing techniques, systems, and materials disclosed herein that enable substrate materials to be incorporated as functional and/or decorative parts of objects.

The techniques and systems described herein can be implemented in a number of ways. Example implementations are provided below with reference to the following figures.

FIG. 1 illustrates example components of an example additive manufacturing system 100 (“system” 100). The system 100 can be configured to manufacture objects by utilizing additive manufacturing principles. In some instances, the system 100 be considered a fused deposition Modeling® (FDM®) system, a fused filament fabrication (FFF) system, or more generally, a 3D printing system (or 3D printer).

The system 100 can include a computer-aided design (CAD) system 102 to provide a digital representation of an object part 104 to be formed by the system 100. Any suitable CAD software program can be utilized for the CAD system 102, such as Solidworks®, to create the digital representation of the object part 104. For example, a user can design, using a 3D modeling software program (e.g., Solidworks®) executing on a host computer, the bottle-shaped object part 104 shown in FIG. 1A that is to be manufactured using the additive manufacturing system 100.

In order to translate the geometry of the object part 104 into instructions usable by a controller 106 in forming the object part 104, the CAD system 102 can mathematically slice the digital representation of the object part 104 into multiple horizontal layers. The CAD system 102 can then design build paths along which build material is to be deposited in a layer-by-layer fashion to form the object part 104.

The controller 106 can manage and/or direct one or more components of the system 100, such as an extrusion head 108, by controlling movement of those components according to a numerically controlled computer-aided manufacturing (CAM) program along computer-controlled paths. The movement of the various components, such as the extrusion head 108, can be performed by the use of stepper motors, servo motors, and the like.

The controller 106 and the CAD system 102 can, in some cases, be parts of a single system that provides digital representations of the object part 104 and controls the components of the system 100. The controller 106 can be implemented in any suitable hardware and/or software processing unit configured to execute instructions stored in computer-readable media for carrying out the techniques disclosed herein. In this sense, computer-readable media can include, at least, two types of computer-readable media, namely computer storage media and communication media. Computer storage media can include volatile and non-volatile, removable, and non-removable media implemented in any method or technology for storage of information, such as computer readable instructions, data structures, program modules, or other data. The system memory, the removable storage and the non-removable storage are all examples of computer storage media. Computer storage media includes, but is not limited to, random access memory (RAM), read-only memory (ROM), erasable programmable read-only memory (EEPROM), flash memory or other memory technology, compact disc read-only memory (CD-ROM), digital versatile disks (DVD), or other optical storage, magnetic cassettes, magnetic tape, magnetic disk storage or other magnetic storage devices, or any other non-transmission medium that can be used to store the desired information and which can be accessed by the controller 106. In contrast, communication media can embody computer-readable instructions, data structures, program modules, or other data in a modulated data signal, such as a carrier wave, or other transmission mechanism. As defined herein, computer storage media does not include communication media.

The extrusion head 108 can be configured to extrude build material onto a substrate 110 during the process of printing the object part 104. The extrusion head 108 can be any suitable type of extrusion head 108 configured to receive material and to extrude the material in a molten state through a nozzle 112 (or tip) that includes an orifice from which fluent strands or “roads” of the material can be deposited onto the substrate 110 in a layer-by-layer manner to form the object part 104. In some cases, as material is supplied to the extrusion head 108, the material enters the extrusion head 108 where it is heated by a heating element inside the extrusion head 108 to a temperature that causes the material to become flowable. The temperature applied to the material in the extrusion head 108 can vary depending on the material being heated. For example, a first temperature can be applied to heat a first material and a second temperature can be applied to heat a second material.

The temperature applied to heat the material in the extrusion head 108 can be at least about 150° C., at least about 170° C., at least about 190° C., or at least about 210° C. The temperature applied to heat the material in the extrusion head 108 can also be no greater than about 350° C., no greater than about 300° C., no greater than about 280° C., no greater than about 260° C., or no greater than about 240° C. In an illustrative example, the temperature applied to heat the material in the extrusion head 108 can be included in a range of about 135° C. to about 360° C. In another illustrative example, the temperature applied to heat the material in the extrusion head can be included in a range of about 230° C. to about 290° C.

Additionally, the temperature applied to heat the material in the extrusion head 108 can be based on a glass transition temperature of the material. For example, the temperature applied to heat the material in the extrusion head 108 can be within about 2° C. of the glass transition of the material, within about 5° C. of the glass transition temperature of the material, within about 8° C. of the glass transition temperature of the material, within about 14° C. of the glass temperature of the material, within about 20° C. of the glass transition temperature of the material, or within about 25° C. of the glass transition temperature of the material.

The substrate 110 can be positioned on a platform 114 that is configured to support the substrate 110. In this manner, the substrate 110 can be provided on the platform 114 as a “working surface” for building the object part 104 on the substrate 110. The substrate 110 can be removably mounted, attached or fastened to the platform 114 by any suitable attachment mechanism including, without limitation, one or more bolts, clamps, hooks, latches, locks, nails, nuts, pins, screws, slots, retainers, adhesive, Velcro®, tape, or any other suitable attachment mechanism that allows for the substrate 110 to be secured to the platform 114 during the formation of the object part 104, yet removable after the object part 104 is formed. In some cases, suction can be applied to the substrate 110 to hold the substrate 110 in place during formation of the object part 104. For example, one or more holes can be provided in the platform 114 and suction, or a vacuum, can be applied via the one or more holes to force the substrate 110 toward the platform 114. In some examples, mounting the substrate 110 on the platform 114 can include setting (laying or placing) the substrate 110 on the platform 114 without any additional securing mechanism.

The substrate 110 can be of any suitable shape and size. In the illustrative figures, the substrate 110 is shown as being a basic square shape having a substantially flat surface on which the object part 104 is to be formed. However, any suitable shape, including, but not limited to, a rectangle, circle, triangle, trapezoid, or any other polygonal shape can be utilized for the substrate 110. In some examples, a square-shaped substrate 110 can be about 100 mm in width and about 100 mm in length. In some examples, the substrate 110 can comprise a 3D support structure or frame that is to become part of the completed object. In this scenario, the substrate 110 can resemble scaffolding or some other “skeleton-like” support structure, but unlike typical scaffolding that is often of a temporary nature (i.e., discarded after completion of a project), at least a portion of the substrate 110 can be incorporated in the completed object.

The substrate 110 can include a polymeric material. In some cases, the substrate 110 can include a coating of the polymeric material. In other instances, the substrate 110 can be made substantially of the polymeric material. In an example, the substrate 110 can include a thermoplastic polymer. The substrate 110 can also include a polyester. Additionally, the substrate 110 can include a glycol-modified polyethylene terephthalate. Further, the substrate 110 can include a copolymer. To illustrate, the substrate 110 can include a copolyester. The substrate 110 can also include polylactic acid, acrylonitrile butadiene styrene, a polycarbonate, a polyamide, a polyetherimide, a polystyrene, a polyphenylsulfone, a polysulfone, a polyethersulfone, a polyphenylene, a poly(methyl methacrylate), or a combination thereof.

During operation of the system 100, the substrate 110 can be initially positioned below the nozzle 112 of the extrusion head 108 in a direction along the Z-axis shown in FIG. 1 at a time prior to the first layer of build material being deposited. The distance at which the substrate 110 is spaced below the nozzle 112 can be any suitable distance allowing for the deposition of fluent strands or “roads” of build material at a desired thickness. In some instances, a distance between the substrate 110 and the nozzle 112 prior to deposition of the first layer of build material can be within a range from about 0.02 mm to about 4 mm. As layers of the object part 104 are deposited, the extrusion head 108 can be incremented a distance in the Z-direction that allows for depositing a next layer of the object part 104 at a desired thickness. In some examples, the incremented distance can be about 0.1 mm.

The system 100 further includes a build material supply 116 and a build material supply line 118 connecting the build material supply 116 to the extrusion head 108 for supplying the build material to the extrusion head 108 during the additive manufacturing process. The material supply 116 can include a material bay or housing containing a spool of build material filament that can be unwound from the spool by a motor or drive unit as the build material is supplied to the extrusion head 108, is heated therein, and is extruded through the nozzle 112. In some examples, the supply of the build material through the build material supply line 118 can be turned on or off, and the build material can be advanced in both forward and backward directions along the build material supply line 118. Retraction of the build material along the build material supply line 118 in a direction toward the build material supply 116 can be advantageous to prevent “drool” at the nozzle 112 and/or return unused build material to the build material supply 116 after finishing an object part. Moreover, the rate at which the build material is supplied to the extrusion head 108 can be controlled by the controller 106 or another processing unit to direct a drive unit (e.g., worm drive) at varying speeds so that speeds can be increased or decreased, and/or nozzles 112 of varying-sized orifices can be utilized for depositing roads of different thickness from the nozzle 112.

Filaments of the build material can have a diameter of at least about 0.5 mm, at least about 1 mm, at least about 1.5 mm or at least about 2 mm. In addition, filaments of the build material can have a diameter no greater than about 7 mm, no greater than about 5 mm, no greater than about 3 mm, or no greater than about 2.5 mm. In an illustrative example, the diameter of filaments of the build material can be included in a range of about 0.2 mm to about 10 mm. In another illustrative example, the diameter of filaments of the build material can included within a range from about 1.75 mm to about 2.85 mm.

The nozzle 108 of the additive manufacturing system 100 can move along the rails 120, 122 at a speed of at least about 5 mm/second, at least about 10 mm/second, at least about 25 mm/second, at least about 50 mm/second, at least about 75 mm/second or at least about 125 mm/second. In addition, the nozzle 108 of the additive manufacturing system 100 can move along the rails 120, 122 at a speed no greater than about 400 mm/second, no greater than about 350 mm/second, no greater than about 300 mm/second, no greater than about 250 mm/second, no greater than about 200 mm/second, or no greater than about 150 mm/second. In an illustrative example, the nozzle 108 of the additive manufacturing system 200 can move along the rails at a speed included in a range of about 2 mm/second to about 500 mm/second. In another illustrative example, the nozzle 108 can move along the rails 120, 122 at a speed included in a range of about 20 mm/second to about 300 mm/second. In an additional illustrative example, the nozzle 108 of the additive manufacturing system 200 can move along the rails at a speed included in a range of about 30 mm/second to about 100 mm/second.

The build material supply 116 can include any suitable material for forming the object part 104. For example, the build material supply 116 can include a polymeric material. In some cases, the build material supply 116 can include a thermoplastic polymer. The build material supply 116 can also include a polyester. Additionally, the build material supply 116 can include a glycol-modified polyethylene terephthalate. Further, the build material supply 116 can include a copolymer. To illustrate, the build material supply 116 can include a copolyester. The build material supply 116 can also include polylactic acid, acrylonitrile butadiene styrene, a polycarbonate, a polyamide, a polyetherimide, a polystyrene, a polyphenylsulfone, a polysulfone, a polyethersulfone, a polyphenylene, a poly(methyl methacrylate), or a combination thereof.

The materials used to form the object part 104 can include various additives. For example, the build material used to produce the object part 104 can include pigment or dye to alter a color of the build material. The build material can also include other additives that affect the optical properties of the object part 104. The substrate 110 can also include additives that alter the color of the substrate 110. In some instances, the build material used to produce the object part 104 and the substrate 110 can be different colors. In this way, an object formed by the additive manufacturing system 100 can include portions having different colors.

In some cases, the substrate 110 can have different optical properties than the optical properties of the object part 104. To illustrate, the substrate 110 can have a haze value that is less than a haze value of the object part 104. The haze values described herein can be measured according to the American Society for Testing and Materials (ASTM) D1003 standard at the time of filing this patent application. In some cases, the substrate 110 can have a haze value that is no greater than about 5, no greater than about 4, no greater than about 3, or no greater than about 2. In illustrative example, the substrate 110 can have a haze value included in a range of about 0.1 to about 6. In another illustrative example, the substrate 110 can have a haze value included in a range of about 1 to about 3. Additionally, the object part 104 can have a haze value of at least about 70, at least about 75, at least about 80, at least about 85, or at least about 90. In an illustrative example, the object part 104 can have a haze value included in a range of about 65 to about 95. In another illustrative example, the object part 104 can have a haze value included in a range of about 83 to about 93. In this manner, the haze value/value of the substrate 110 may be specified relative to the haze value/value of the object part 104 (i.e., the build material after having been deposited via an additive manufacturing process and solidified on a surface of the substrate 110) by a percent difference. The percent difference between the two haze values can be defined as a ratio of the difference between the two haze values and the average of the two haze values, shown as a percentage. In other words, the percent difference between the two haze values can be defined as the difference between the two haze values divided by the average of the two haze values, shown as a percentage. Equation (1) is an example of the percent difference calculation:

$$Percent Difference = \frac{\vert {Haze}_{1} - {Haze}_{2} \vert}{( \frac{{Haze}_{1} + {Haze}_{2}}{2} )} \times 100 \% \qquad Eq . ( 1 )$$

In Equation (1), Haze1 can represent the haze value/value of the substrate 110, and Haze2 can represent the haze value/value of the object part 104, or vice versa. In one example, the percent difference between the haze value of the substrate 110, and the haze value of the object part 104 can be at least about 165%. In some examples, the percent difference between the two haze values can be at least about 175%, at least about 185%, or at least about 195%.

By forming an object with a substrate 110 having a first haze value and an object part 104 having a second haze value different from the first haze value, the appearance of objects produced using the additive manufacturing system 100 can be tailored to exhibit particular characteristics. For example, an object can be formed having a substantially transparent portion and a somewhat opaque portion. To illustrate, an object including the object part 104 and the substrate 110 can have a transparent portion made up of at least a portion of the substrate 110 and a more opaque portion made up of the object part 104.

As build material is supplied to the extrusion head 108, the controller 106 directs the movement of the extrusion head 108 along horizontal guide rails 120 and/or vertical guide rails 122 so that the extrusion head 108 can follow a predetermined build path while depositing build material for each layer of the object part 104. In this sense, the guide rails 120 and 122, such as a gantry, allow the extrusion head 108 to move two-dimensionally and/or three-dimensionally in vertical and/or horizontal directions as shown by the arrows in FIG. 1A. Additionally, or alternatively, the platform 114 can be movable in two-dimensions and/or three-dimensions, and such movement can be controlled by the controller 106 to provide similar relative movement between the substrate 110 and platform 114 and the extrusion head 108 so that multiple roads of build material can be deposited by moving the extrusion head 108 and/or the platform 114 in a two-dimensional (2D) horizontal plane (i.e., X-Y plane) to form each layer of the object part 104, and then multiple successive layers can be deposited on top of one another by moving the extrusion head 108 and/or the platform 114 in a vertical Z-direction.

The object part 104 can be formed in a controlled environment, such as by confining individual ones of the components of the system 100 (e.g., the substrate 110, the extrusion head 108 and the nozzle 112, etc.) to a chamber or other enclosure where temperature, and perhaps other parameters (e.g., pressure) can be controlled and maintained at a desired level by elements configured to control temperature, pressure, etc. (e.g., heating elements, pumps, etc.). In some instances, the temperature applied to the build material can correspond to a temperature at or above the creep-relaxation temperature of the build material. This can allow more gradual cooling of the build material as it is deposited onto the substrate 110 so as to prevent warping of the layers of the object part 104 upon deposition. On the other hand, an environment that is maintained at a temperature that is too high for a given build material can cause the build material formed on the substrate 110 to droop before it is solidified in the object part 104, potentially causing distortions in the final shape of the object part 104.

Additionally, the platform 114 can be heated. For example, the platform 114 can be heated at a temperature of at least about 35° C., at least about 45° C., or at least about 60° C. In another example, the platform 114 can be heated at a temperature no greater than about 120° C., no greater than about 110° C., no greater than about 100° C., no greater than about 85° C., or no greater than about 70° C. In an illustrative example, the platform 114 can be heated at a temperature included in a range of about 30° C. to about 125° C. In another illustrative example, the platform 114 can be heated at a temperature included in a range of about 40° C. to about 90° C. Heating the platform 114 can promote an anti-warping effect on the build material used to form the object part 104. Heating of the platform 114 can be performed by any suitable heating elements, such as electrical elements that can be turned on or off, gas heating elements below the platform 114, or any other suitable heating element. Heating the platform 114 can also promote a relatively higher-strength bond at the interface between the object part 104 and the substrate 110 by promoting a greater contact area at the interface between the two parts. In some situations, the platform 114 may not be heated and the platform 114 can have a temperature included in a range of about 15° C. to about 30° C.

As will be described in more detail below with reference to the following figures, the material of the substrate 110 is to be miscible with the build material used to form the object part 104 in order to promote suitable bond strength between the substrate 110 and the build material deposited thereon. The term “miscible,” as used herein, refers to two or more materials that exhibit intimate interactions upon mixing of the two or more materials on a molecular level such that the materials mix in substantially all proportions to form a homogeneous solution. In particular, two materials can be miscible in the absence of an interface between a phase of a first material and a phase of a second material. In some cases, two materials can be considered miscible when a Hildebrand Solubility Parameter of the two materials is substantially the same. Two or more thermoplastic polymers can also be considered to be miscible when a blend or composite of the polymers does not exhibit a visibly-detectable level of haze when viewed at various angles both with and without backlighting. By contrast, two thermoplastic polymers are considered to be immiscible if a significant proportion of a blend or composite of the polymers does not form a homogeneous solution.

Because the extrusion head 108 heats the build material as it is supplied thereto, the nozzle 112 maintains a heated temperature during the additive manufacturing process that is commensurate with the temperature of the flowable build material after being heated within the extrusion head 108. Furthermore, during deposition of a first layer of the object part 104, the heated nozzle 112 is positioned in relatively close proximity to the substrate 110 such that localized heating occurs at a top surface of the substrate 110. For example, the heated nozzle 112 can be positioned as close as about 0.02 mm from the substrate 110 prior to depositing the first layer of build material thereon. Accordingly, the material of at least on the top surface of the substrate 110 can be locally melted during deposition of the first layer of build material as the heated nozzle 112 is positioned over the surface of the substrate 110. This localized melting of the material at the surface of the substrate 110 promotes chain entanglement (i.e., diffusion and entanglement of chain ends across the interface between the object part 104 and the surface of the substrate 110) with the build material as it is deposited on the melted surface of the substrate 110, causing the first layer of the build material to be “melt bonded” or fused to the surface of the substrate 110 upon cooling (i.e., upon solidification of the build material).

A Hildebrand solubility parameter of the build material can be included in a range of about 8 to about 12. In another example, the Hildebrand solubility parameter of the build material can be included in a range of about 9 to about 11. In other examples, the Hildebrand Solubility parameter of the build material can be included in a range of about 10 to about 11. Additionally, a Hildebrand solubility parameter of the substrate 110 can be included in a range of about 8 to about 12. The Hildebrand solubility parameter of the substrate 110 can also be included in a range of about 9 to about 11. In a particular example, the Hildebrand solubility parameter of the substrate 110 can be included in a range of about 10 to about 11. The Hildebrand solubility parameter of the build material and the substrate 110 can be expressed in units of (cal-cm⁻³)^{0.5}.

Further, a Hildebrand solubility parameter of the build material can be within about 5% of a Hildebrand solubility parameter of the substrate 110, within about 3% of a Hildebrand solubility parameter of the substrate 110, within about 1% of a Hildebrand solubility parameter of the substrate 110, within about 0.5% of a Hildebrand solubility parameter of the substrate 110, or within about 0.01% of a Hildebrand solubility parameter of the substrate 110. In some cases, the Hildebrand solubility parameter of the build material can be substantially the same as the Hildebrand solubility parameter of the substrate 110.

Due to the firm bond/attachment created during the process of forming one or more initial layers of the object part 104 onto the surface of the substrate 110, at least a portion of the substrate 110 can be incorporated into a completed object. In this manner, the completed object includes at least two parts joined during the additive manufacturing process: (i) the object part 104 formed from build material deposited onto the substrate 110, and (ii) at least a portion of the substrate 110. In particular, the completed object can include the portion of the substrate 110 onto which the build material is deposited.

A portion of the substrate 110 can be removed to complete the object. In this scenario, the removal of excess substrate 110 that is not to be included in the completed object (“excess substrate”) can be removed in any suitable fashion including, without limitation, stamping, cutting with a physical tool (e.g., a band saw, hacksaw, etc.), scoring and breaking away excess portions of the substrate 110, laser cutting, water jet cutting, abrasivejet cutting, cryojet cutting, and so on. To this end, the additive manufacturing system 100 can further include a material removal component 124, which can include any suitable component for carrying out the suitable removal techniques described herein. In one illustrative example, the material removal component 124 comprises a laser cutter with corresponding laser generation and optical components to focus a laser onto the substrate 110 for removal of a predetermined portion of the substrate 110. The material removal component 124 can be configured to be controlled along the same or similar guide rails 120 and 124 as the extrusion head 108, which can be directed by the controller 106 to move the material removal component 124 along numerically controlled paths according to any suitable CAM program. In some examples, the removal of material from the substrate 110 can be performed after completion of the object part 104. Additionally, removal of excess substrate can be performed before or during the additive manufacturing process, such as before or during the formation of the object part 104.

The substrate 110 can be flipped or turned over in orientation by rotating the substrate 110 about the X-axis (or Y-axis) to expose a bottom surface of the substrate 110 to the material removal component 124. In this manner, the material removal component 124 can traverse the bottom surface of the substrate 110 in a horizontal plane (X-Y plane) without risk of interfering with the object part 104 positioned on the opposite side of the substrate 110 upon inverting the substrate 110. Any material removed from the substrate 110 by the material removal component 124 can be discarded or recycled for reuse (e.g., re-melting the scrap substrate 110 material to form new substrates 110 for use in the additive manufacturing process.

Dimensions of the substrate 110 can vary, and in some instances the thickness (i.e., height in the Z-direction of FIG. 1) can be selected to facilitate the removal of excess substrate material by cutting or otherwise causing fracture through the thickness of the substrate 110. A thickness of the substrate 110 can be at least about 0.2 mm, at least about 0.5 mm, at least about 1 mm, or at least about 2 mm. Additionally, a thickness of the substrate 110 can be no greater than about 10 mm, no greater than about 8 mm, no greater than about 5 mm, or no greater than about 3 mm. In an illustrative example, a thickness of the substrate 110 can be included in a range of about 0.1 mm to about 12 mm. In another illustrative example, a thickness of the substrate 110 can be include within a range of about 1 mm to about 3 mm. The substrate 110 can also be of various shapes, including square, circular, rectangular, triangular, or any suitable polygonal shape.

Although FIG. 1 illustrates one illustrative example of certain components of an additive manufacturing system usable for carrying out the techniques disclosed herein, it is to be appreciated that the configuration and inclusion of certain components shown in FIG. 1 is one, non-limiting, example of a suitable additive manufacturing system. Namely, other types and configurations of additive manufacturing systems can be utilized with the techniques and materials disclosed herein without changing the basic characteristics of the additive manufacturing system 100, and the additive manufacturing system 100 can be implemented as any suitable size for a particular industry or application, such as industrial-sized for commercial object production and/or testing, desktop-sized, handheld for consumer-use, and so on. For example, a handheld additive manufacturing system can be utilized to form the object part 104 on the substrate 110. One illustrative example of a suitable handheld system is the 3Doodler®, a 3D printing pen from WobbleWorks LLC. In this manner, a handheld additive manufacturing tool can be used to “weld” two or more substrates, such as two or more of the substrate 110, together by forming a firm bond at an interface between the build material and each of the two or more substrates 110.

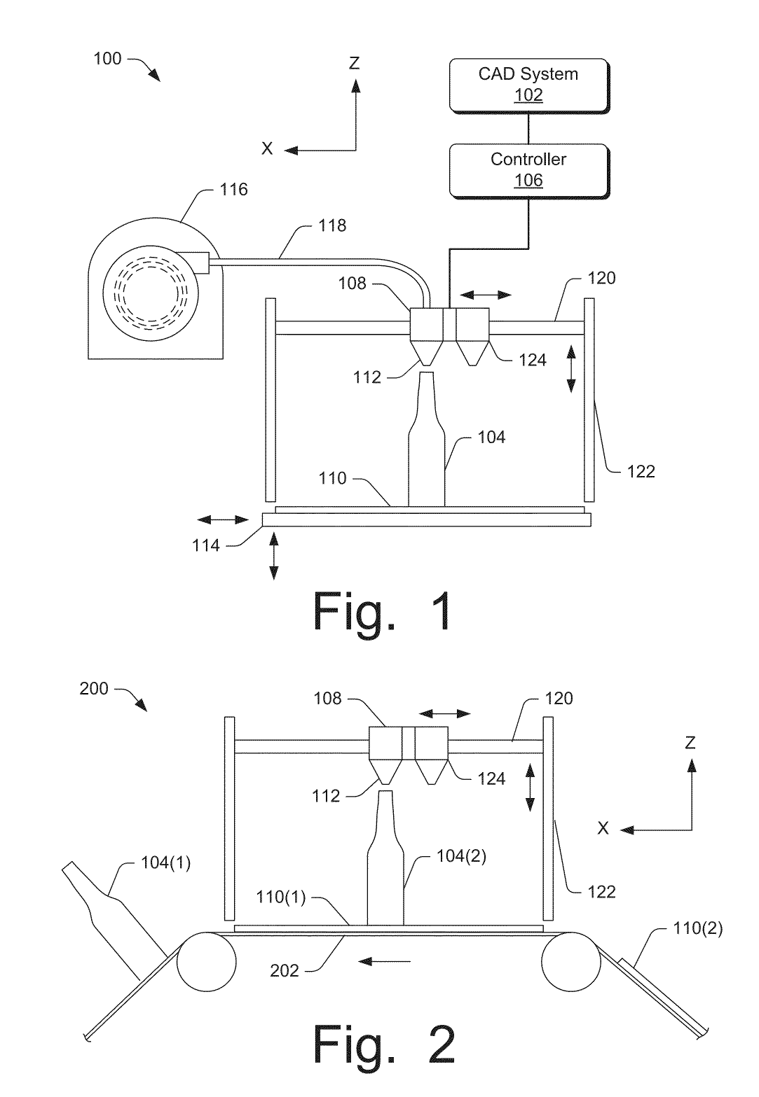

FIG. 2 illustrates example components of an example additive manufacturing system 200 according to another example. In FIG. 2, the platform 114 of FIG. 1 is more or less replaced with a conveyor system 202 that carries substrates 110(1), 110(2), etc., on the conveyor system 202 and positions the substrates, such as the substrate 110(1), under the extrusion head 108 for printing of one or more object parts 104(1) and 104(2) thereon and subsequently moving the conveyor system 202 in order to position a successive substrate, such as the substrate 110(2) under the extrusion head 108 to print another one or more object parts, such as the object part 104(2), thereon. In such a configuration, it is contemplated that the extrusion head 108 can be provided at one location over the conveyor and the material removal component 124 (e.g., a laser cutter) can be positioned upstream or downstream from the extrusion head 108 to remove excess material from the substrate 110 before or after the object parts 104(1) and 104(2) are printed thereon. In some examples, the substrates 110(1) and 110(2) have just recently been formed at a station that is upstream from the system 200 such that the substrates 110(1) and 110(2) are still “hot” from their manufacturing process upon reaching the system 200. This can enable reduction of an environmental temperature of the system 200.

In some examples, the extrusion head 108 and/or the material removal component 124 can be provided on rigid or semi-rigid guide rails, such as the guide rails 120 and 122 shown in FIGS. 1 and 2, while in other examples, the extrusion head 108 and/or the material removal component 124 can be provided on robotic arms. For example, delta robots or other suitable robotic arms can be positioned over the conveyor system 202 and can be controlled by the controller 106 to carry out the additive manufacturing process and material removal features disclosed herein.

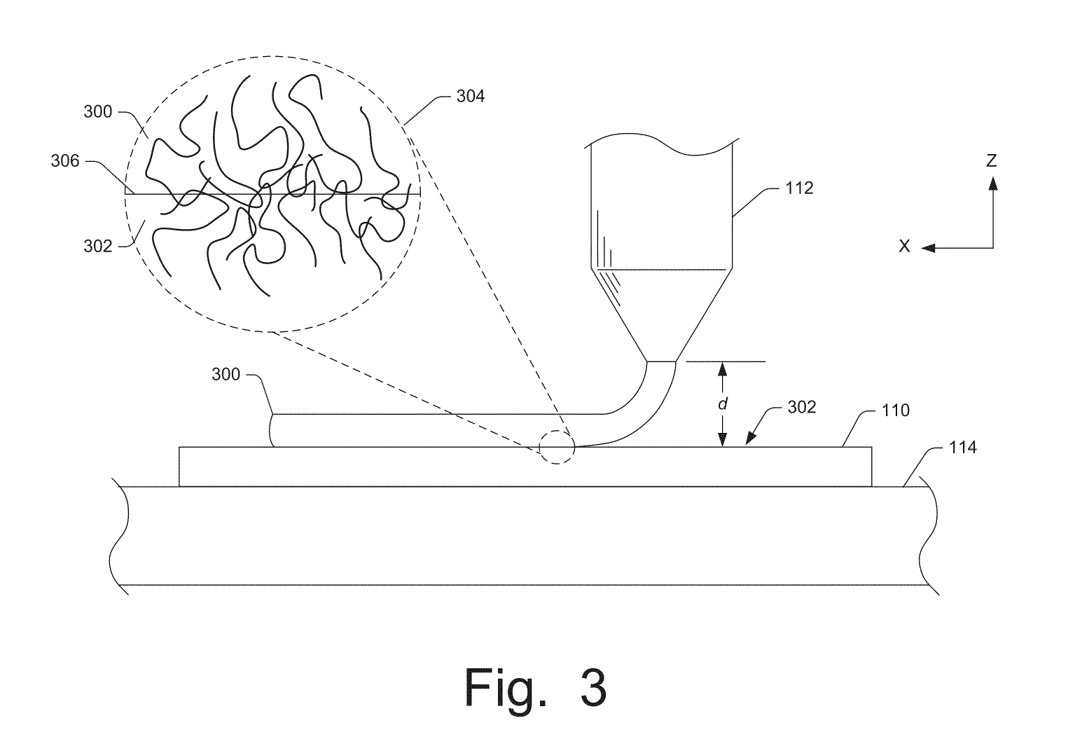

FIG. 3 illustrates a close-up, side view of a first layer 300 of an example object part, such as the object part 104 of FIG. 1, being deposited onto an example substrate, such as the substrate 110 of FIG. 1, during an additive manufacturing process. As discussed above with reference to FIGS. 1 and 2, during the additive manufacturing process of forming a object part 104 onto the substrate 110, build material is supplied to the extrusion head 108 where it is heated and extruded out of the nozzle 112 so that the build material can be deposited in roads onto a surface 302 (e.g., the top surface) of the substrate 110. Accordingly, the first layer 300 of build material that is shown as being deposited onto the surface 302 of the substrate 110 in FIG. 3 can represent a beginning of the additive manufacturing process where the first layer 300 of build material is deposited directly onto the surface 302 according to a predetermined build path. The substrate 110 is shown in FIG. 3 as being supported by a portion of the platform 114. The substrate 110 can be removably attached or fastened to the platform 114 in any suitable manner, such as those described in detail with reference to FIG. 1.

FIG. 3 further illustrates a distance, d, from the distal end of the nozzle 112 to the surface 302 of the substrate 110. As discussed above, during deposition of the first layer 300 of an object part, such as the object part 104 of FIG. 1, the nozzle 112 is positioned in relatively close proximity to the substrate 110 at the distance, d, from the surface 302 of the substrate 110. For example, the nozzle 112 can be positioned as close as about 0.02 mm from the substrate 110. Moreover, because the nozzle 112 is heated due to the heating of the build material within the extrusion head 108, the surface 302 of the substrate 110 can be locally melted during deposition of the first layer 300 of build material as the heated nozzle 112 is positioned over the surface 302 of the substrate 110 at the distance, d, and as the nozzle 112 moves at a predetermined speed across the surface 302.

FIG. 3 further illustrates a zoomed-in view 304 of a portion of an interface 306 between the first layer 300 of the deposited build material and the surface 302 of the substrate 110. At least the surface 302, and perhaps the entirety of, the substrate 110 can be made of a first material, such as any of the thermoplastic polymers, individually or in combination, described above. Furthermore, the build material deposited in the first layer 300 can be made of a second material that is miscible with the first material. In some cases, the first material and the second material are the same material, while in other instances, the first and second material can be different materials that are nonetheless miscible with each other. For example, a first thermoplastic polymer of the substrate 110 can be similar to a second thermoplastic polymer of the build material used for building the object part 104, but the first thermoplastic polymer can differ in a few properties (e.g., Hildebrand solubility parameter, additives like titanium dioxide, calcium carbonate, pigments, etc.). Despite the differing properties between the first and second thermoplastic polymers, the two polymers can form a firm attachment when the second thermoplastic polymer is printed onto the first thermoplastic polymer that is miscible with the second thermoplastic polymer.

The zoomed-in view 304 illustrates that, due to the localized melting of the first material at the surface 302 of the substrate 110, chain entanglement (i.e., diffusion, and entanglement, of chain ends across the interface 306 between the first layer 300 and the surface 302) is promoted between the extruded first layer 300 of the second material and the locally melted surface 302 of the substrate 110. This causes the first layer 300 of the extruded second material to be “melt bonded” or otherwise fused to the surface 302 of the substrate 110 upon cooling, and a firm bond or attachment is created thereby. Because a portion of the substrate 110 is to be incorporated into a completed object (at least where the bond occurs at the surface 302), the high strength bond created by this process is desirable for improved attachment of the portion of the substrate 110 and the object part 104 that make up the completed object.

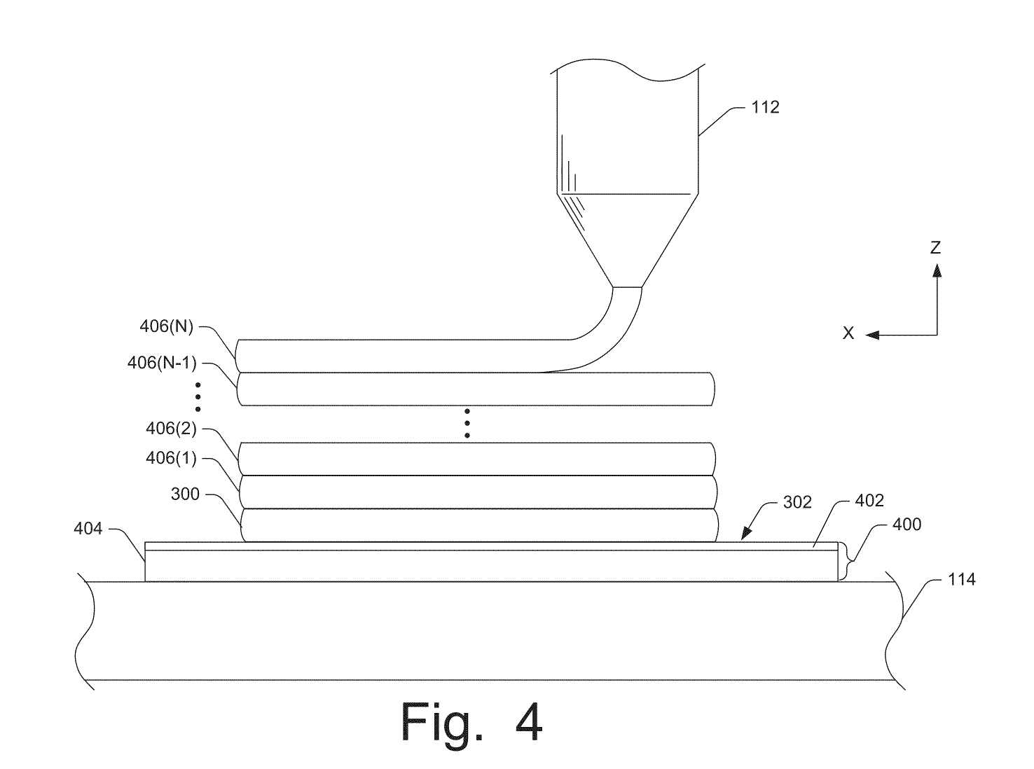

FIG. 4 illustrates a close-up, side view of layers of an example object part, such as the object part 104, being deposited during an additive manufacturing process according to another example. In the example of FIG. 4, a substrate 400 is shown as having a top layer 402 (“surface layer 402”) that is made of a first material, and a main portion 404 that can be made of any other suitable material. For example, the substrate 400 of FIG. 4 can be comprised of a main portion 404 made of wood, fibreboard (e.g., medium-density fibreboard (MDF)), metal, glass, plastic, or any other suitable material. The main portion 404 can also be coated with a first material (e.g., a thermoplastic polymer) forming the top layer 402, where the first material is miscible with a second material used as the build material of the object part 104. Any suitable process of forming a top layer 402 of a first material on a main portion 404 to make up the substrate 400 can be used.

In some examples, the substrate 400 can comprise multiple layers of different material, such as a top layer 402, one or more intermediate layers, and a bottom layer. The top, intermediate, and bottom layers can allow for any combination of layers having different properties, such as some of the substrate layers being clear or substantially opaque, colored, and so on. So long as the top layer 402 is miscible with the first layer 300 of the build material, there can be a firm bond created at the interface 306 upon forming the first layer 300 of the build material on the top layer 402 of the substrate 400. Additional intermediate layers can be provided to add different properties, such as pigments, clear layers, and the like.

In a similar manner to that which was described with reference to FIG. 3, the top layer 402 of the first material allows for the above-described firm bond or attachment between the top layer 402 at the surface 302 and the first layer 300 of the second material after the second material is deposited and cools on the surface 302 of the substrate 400. FIG. 4 further illustrates that multiple additional layers 406(1), 406(2), . . . , 406(N−1), 406(N) of the second material (i.e., the build material) can be deposited as the additive manufacturing process proceeds by depositing the second material in a layer-by-layer fashion to form the object part 104 on the substrate 400.

The layer height, or thickness (in the Z-direction of FIG. 4), of each of the first layer 300, and the multiple additional layers 406(1)-(N) can be of any suitable height/thickness to provide the desired “resolution” to the finished object part 104. Furthermore, each of the first layer 300, and the multiple additional layers 406(1)-(N) can be of uniform height or of varying heights. The layer height of any individual layer (i.e., the first layer 300 and/or the multiple additional layers 406(1)-(N)) can be at least about 0.1 mm, at least about 0.15 mm, at least about 0.2 mm, or at least about 0.25 mm. Additionally, the layer height of any individual layer can be no greater than about 1 mm, no greater than about 0.75 mm, no greater than about 0.5 mm, no greater than about 0.4 mm, no greater than about 0.35 mm, or no greater than about 0.3 mm. In an illustrative example, a layer height of any individual layer can be included in a range of about 0.15 mm to about 0.4 mm.

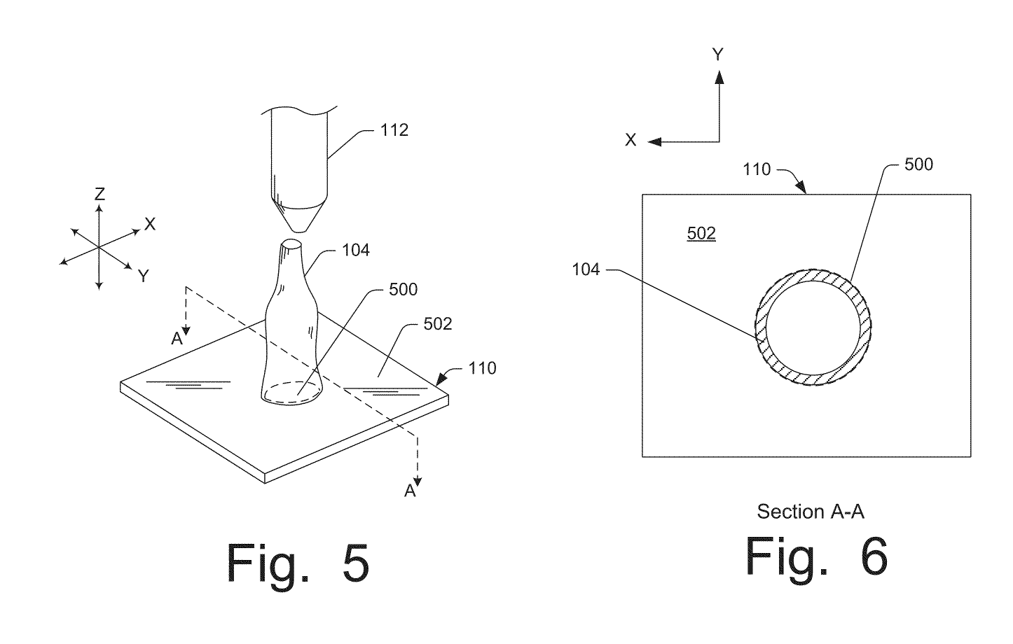

FIG. 5 illustrates a partial perspective view of example components of an example additive manufacturing system illustrating a portion 500 of the substrate 110 that is to be incorporated into a completed object and a portion 502 of the substrate 110 that is to be removed, respectively. FIG. 5 shows the substrate 110 of FIGS. 1-3, but it is to be appreciated that the substrate 400 of FIG. 4 can be provided for the example shown in FIGS. 5 and 6. FIG. 6 illustrates a top view of the object part 104 and the substrate 110 of FIG. 5 along section line A-A. In the example shown in FIGS. 5 and 6, the object part 104 is bottle-shaped, and was formed by the additive manufacturing process described herein, although any conceivable object part having a different shape can be formed with the additive manufacturing process. Namely, the nozzle 112 in FIG. 5 has extruded a material in a layer-by-layer fashion according to predetermined build patterns onto the substrate 110 to form the object part 104. The substrate 110 can be at least coated with, if not made entirely from, a first material that is miscible with the extruded material (“second material”), thereby forming a firm attachment at the interface between the deposited first layer of the extruded/second material (build material) and the first material of the substrate 110 upon deposition of the first layer of build material.

In an example, a portion 500 of the substrate 110 is to be incorporated into the completed object. In this example, the portion 500 comprises a bottom of the bottle-shaped object part 104. The portion 500 can be defined by an area within a periphery of the deposited first layer of build material. In this example, the first layer was deposited onto the substrate 110 in a circular pattern with an area of the substrate 110 inside the circle remaining uncovered by any build material. In this example, as the layers 406(1)-(N) of build material are added to previously deposited layers, the object part 104 can be formed with at least a partially hollow interior portion of the object part 104. In other words, the object part 104 can be printed with something less than 100% infill (i.e., interior/internal material), and the side walls can be printed directly onto the substrate 110. In this illustrative example, the object is substantially hollow with a predetermined side wall thickness that can have a minimum threshold of a thickness of a deposited road of extruded build material. In this scenario, imagine a substrate 110 made of a transparent thermoplastic polymer where the substrate 110 was formed by injection-molding or extrusion (i.e., the thermoplastic polymer was drawn through a die). For example, the thermoplastic polymer may have a haze value included in a range of about 0.1 to about 6. This transparent substrate 110 allows for the portion 500 to act as a transparent portion of a completed object (in this case, a bottle with a transparent bottom portion), where the object part 104, if printed with a second thermoplastic polymer that is otherwise transparent, can exhibit a frosted or opaque appearance due to known limitations in extrusion-based additive manufacturing systems.

Other applications can be envisioned using the techniques, systems, and materials disclosed herein, such as objects like containers (e.g., cosmetics containers) having transparent portions, or any other decorative and/or functional object. For example, functional object parts 104 (e.g., fixture points, stand-offs, etc.) can be printed onto a substrate 110 to add functionality to a completed object comprising a portion of the substrate 110 and the functional object part 104. In another example, the material of the substrate 110 can be pigmented a different color than the material of the build material used for forming the object part 104 to offer a decorative or functional colored appearance to the portion 500. Although the object part 104 shown in FIGS. 5 and 6 is shown as having been printed as an unfilled, circular pattern for the first layer that is deposited onto the substrate 110, it is to be appreciated that any filled or unfilled pattern, shape, or series of patterns or shapes can be printed onto the substrate 110 using the additive manufacturing process described herein.

In some instances, the portion 502 of the substrate 110 is to be removed for completing the formation of a completed object. The portion 502, which can be referred to as a “remainder” of the substrate 110 (or the “body” of the substrate 110) that is not the portion 500 to be incorporated into the completed object, can be removed in any suitable manner, such as those described in detail above with reference to FIGS. 1 and 2. For example, the material removal component 124, such as a laser cutter, can be utilized by the additive manufacturing system 100 to cut around a boundary of the portion 500 so that the portion 502 can be removed and discarded or recycled (e.g., re-melted and used to form additional substrates 110). In some examples, the entire substrate 110 can be incorporated into a completed object. Furthermore, according to some examples, the portion 502 can be removed prior to formation of the object part 104 onto the portion 500. For example, the substrate 110 can be positioned on the platform 114 and the material removal component 124 can remove the portion 502, which can be predetermined and designated using a CAD model of the object. The controller 106 can then control the material removal component 124 to move in a computer-controlled manner along a path that defines a boundary of the portion 500. The portion 502 can thereby be removed, and the portion 500 can be optionally re-centered or re-positioned on the platform 114 under the nozzle 112 of the extrusion head 108, and perhaps removably attached to the platform 114 so that the additive manufacturing process can be carried out on the portion 500.

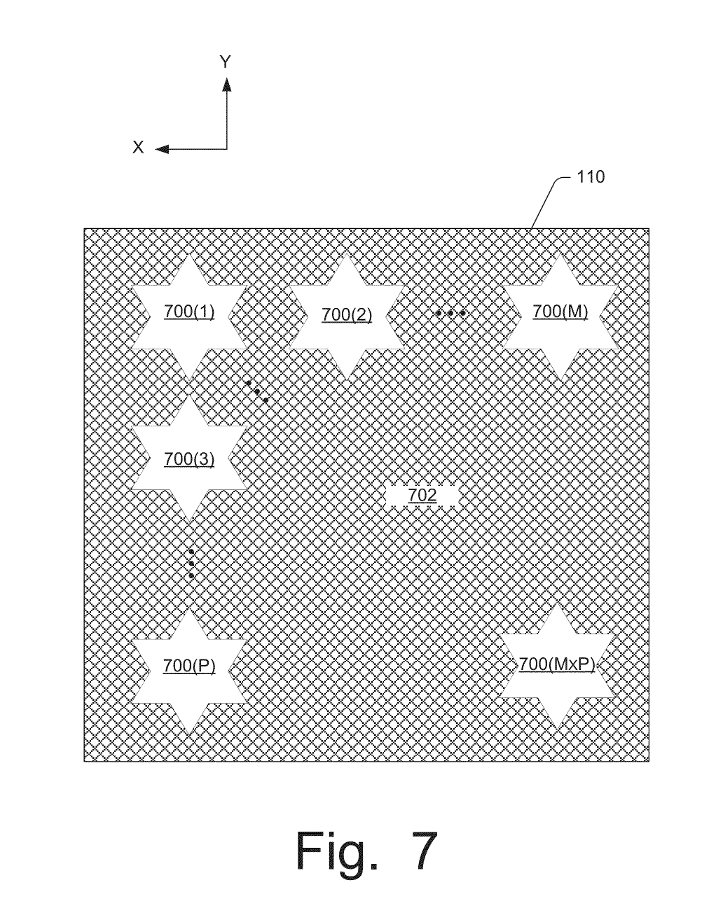

FIG. 7 illustrates a top view of an example substrate, such as the substrate 110 of FIG. 1, having a plurality of portions 700(1)-700(MxP) that are to be incorporated into objects formed by an additive manufacturing process. In FIG. 7, the portions 700(1)-700(MxP) are designated on the substrate 110 in an array, although any regular or irregular pattern or arrangement of the portions 700(1)-700(MxP) can be provided. The designation of the portions 700(1)-700(MxP) can be enabled by a CAM program that processes a 3D model of an object part 104 to determine a number and placement of the portions 700(1)-700(MxP) that can be provided on the substrate 110. In this example, the number and arrangement of the portions 700(1)-(MxP) can be determined based on the size or dimensions of the object part 104 to be printed on the substrate 110, as well as the size or dimensions of the substrate 110 in order to maximize the combined area of the portions 700(1)-700(MxP) and to minimize an area of a portion 702 that is to be removed for completing multiple objects using the substrate 110. This can minimize waste material from the substrate 110 and can allow for maximized throughput in mass or rapid manufacturing environments.

The shapes of the portions 700(1)-700(MxP) can be the same or different, and can represent an area within which the first layer of an object part 104 is to be printed on. In some examples, the first layer can cover the entire area of individual ones of the portions 700(1)-700(MxP), or the first layer can cover only a sub-area of individual ones of the portions 700(1)-700(MxP), such as the outline or border of the portions 700(1)-700(MxP).

### Example Process

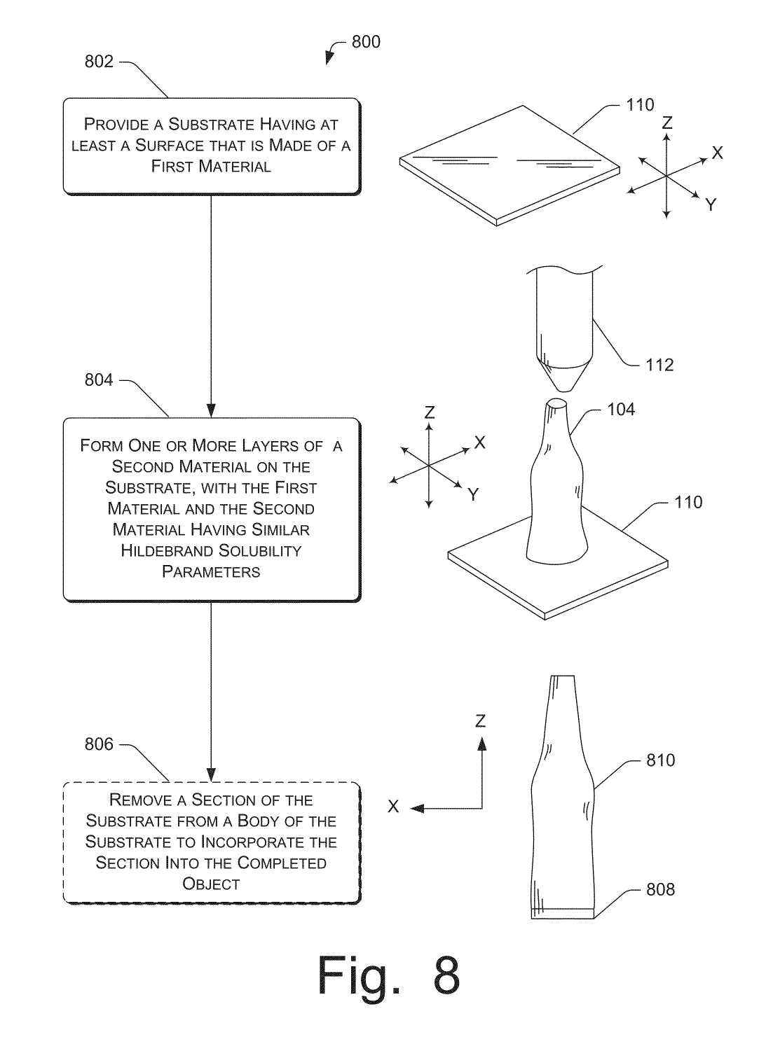

FIG. 8 is flow diagram of an illustrative process 800 of forming an object using an additive manufacturing system, such as the system 100 of FIG. 1. The processes are illustrated as a collection of blocks in a logical flow graph, which represent a sequence of operations that can be implemented, at least in part, by an extrusion-based additive manufacturing system. The order in which the operations are described is not intended to be construed as a limitation, and any number of the described blocks can be combined in any order and/or in parallel to implement the process. For discussion purposes, the process 800 is described with reference to the system 100 and components thereof that are described with reference to FIGS. 1-7.

At 802, a substrate, such as the substrate 110, can be provided for forming thereon an object part. The substrate can have at least a surface that is made of a first material, such as those described in detail above, individually or in combination. For example, a top layer of the substrate, such as the top layer 402 shown in FIG. 4, can be formed (e.g., coated) on a main portion 404 of the substrate, such as the substrate 400. Alternatively, the substrate can be made entirely of the first material. In some examples, the providing the substrate at 802 can comprise removably mounting or attaching a preformed substrate to a platform, such as the platform 114. In other examples, providing the substrate 802 can further comprise creating the substrate by a suitable manufacturing technique, such as injection-molding, extrusion (i.e., advancing the first material through a die), blow-molding, compression molding, casting, or any other suitable method of making the substrate.

At 804, a second material that is miscible with the first material can be extruded onto at least a portion of the substrate that is to be incorporated into a completed object. That is, one or more layers of the second material can be formed on the surface of the substrate, wherein a Hildebrand solubility parameter of the second material is within about 5% of a Hildebrand solubility parameter of the first material. In some examples, the forming at 804 includes positioning a heated nozzle 112 of the additive manufacturing system 100 a predetermined distance from the surface of the substrate and moving the nozzle 112 at a predetermined speed across the surface of the substrate in order to melt the first material of the substrate underneath the nozzle 112 to promote firm bonding with the extruded second material (build material). The forming at 804 can occur until an object part 104 is printed onto and bonded to at least a portion of the substrate. In some examples, the forming of the one or more layers of the second material onto the substrate occurs in predetermined patterns to build the object part 104 in a layer-by-layer fashion according to 3D model data processed by the additive manufacturing system 100. In some examples, the forming at 804 is repeated on different portions of the substrate, such as when multiple object parts are to be formed on the same substrate.

In some examples, the process 800 can include an optional step 806 of removing a section of the substrate (a section that is not the portion of the substrate to be incorporated into the completed object) from a body of the substrate (i.e., the remainder of the substrate) so that the removed section can be incorporated into the completed object. The step 806 is optional because, in some cases, the entire substrate can be incorporated as part of the completed object. However, in scenarios where only a portion of the substrate, such as the portion 500 of FIGS. 5 and 6, is to be incorporated into the completed 3D object, step 806 can be carried out either before or after step 804 even though step 806 is shown as occurring after step 804 in FIG. 8. The removal of a section of the substrate at 806 can be performed by any suitable removal technique, such as any of those described in detail above (e.g., laser cutting the excess substrate from the section that is to be incorporated).

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

The concepts described herein will be further described in the following examples with reference to the following figures, which do not limit the scope of the disclosure described in the claims.

### EXAMPLES

### Example 1

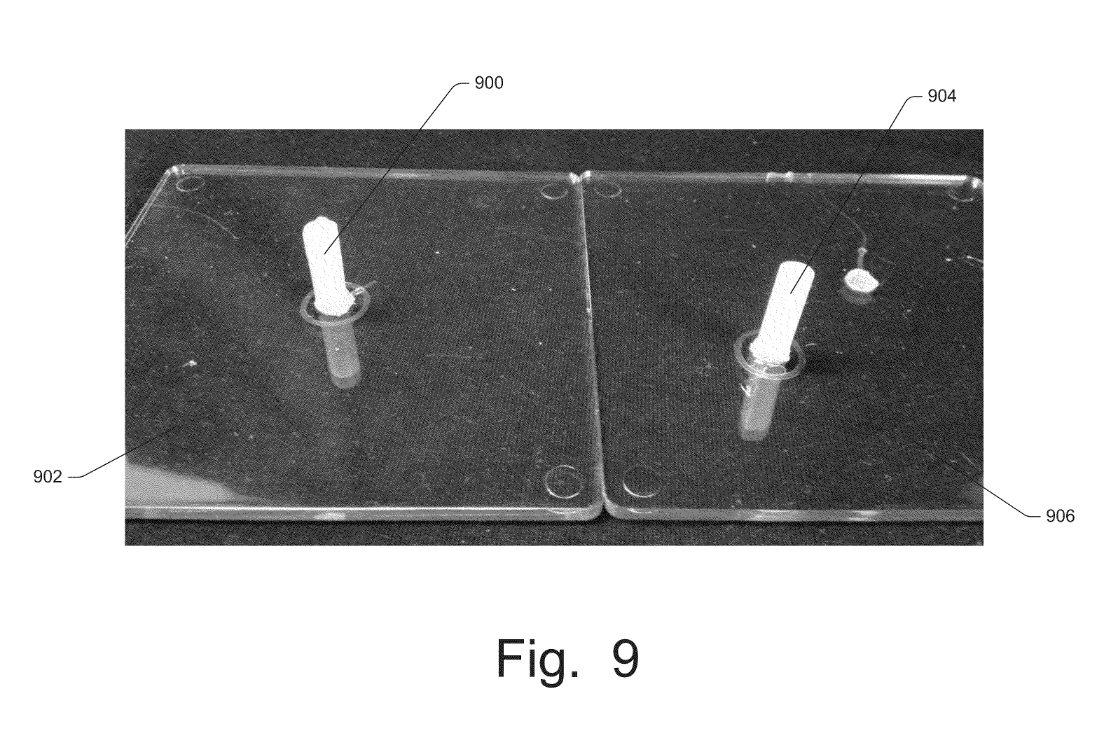

FIG. 9 shows a first object part 900 that was formed on a first substrate 902 and a second object part 902 that was formed on a second substrate 906 using an extrusion-based additive manufacturing system. In this example, the first and second object parts 900 and 904 are “pins”, or cylindrical object parts, that were formed using an Ultimaker® 3D printer. Each of the first object part 900 and the second object part 904 are approximately 6 mm in diameter and approximately 25 mm in height. The material used to form the first and second objects parts 900 and 904 is a copolyester of the brand name TRITAN™ (specifically TRITAN™ TX1500HF copolyester), which is commercially available from Eastman Chemical Company®. The material used to form the first and second substrates 902 and 906 is also TRITAN™ TX1500HF copolyester. The substrates 902 and 906 were formed by injection molding the TRITAN™ TX1500HF copolyester into the shape of the substrates 902 and 906, while the first and second object parts 900 and 904 were formed by depositing the TRITAN™ TX1500HF copolyester onto a surface of the substrates 902 and 906 using the Ultimaker® 3D printer. During the formation of the first and second object parts 900 and 904, the Ultimaker® 3D printer was set at 260° C. for the temperature of the build material in the extrusion head 108, 0.1 mm layer height, and 100% infill (i.e., the first and second object parts 900 and 904 are solid object parts). Each of the substrates 902 and 906 measure approximately 100 mm×100 mm×3 mm.

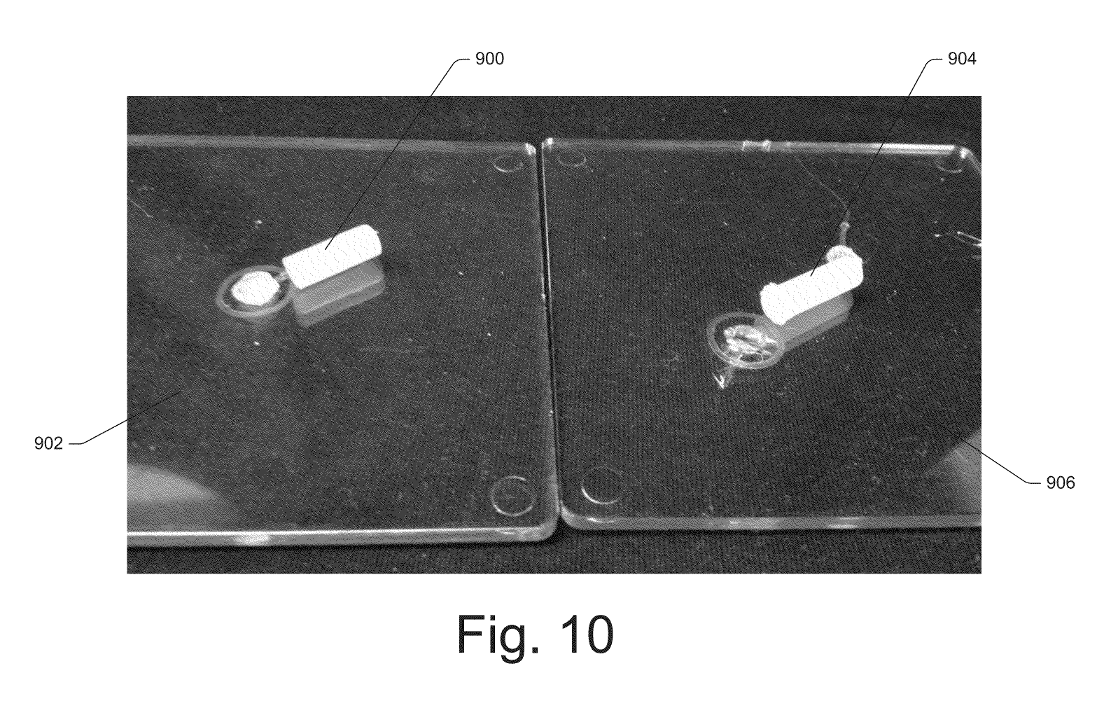

FIG. 10 shows the first object part 900 and the second object part 904 of FIG. 9 after applying respective forces to separate the first object part 900 from the first substrate 902 and the second object part 904 from the second substrate 906. The shear force that was applied to the top ends of the first and second object parts 900 and 904 was enough force to cause failure. This application of a transverse force to the top ends of the first and second object parts 900 and 904 is more-or-less a “shear test” to determine whether a suitable attachment/bond has been created at an interface 306 between each of the object parts 900, 904 and the respective substrates 902, 906 on which the object parts 900, 904 were printed. Such a shear test can be used as a process to indirectly determine whether two materials used with the techniques and systems disclosed herein are in fact miscible. Using miscible materials for the materials of the substrates 902, 906 and the build material of the object parts 900, 904 allows for a suitable strength bond/attachment to be created at the interface 306 between the two parts of the completed object.

The result of the shear test for the first object part 900 is illustrated in FIG. 10 where, upon failure, the failure occurred above the interface 306 and within the first object part 900 (roughly 2 mm above the surface of the first substrate 902), which is indicative of a suitably firm attachment at the interface 306 (i.e., the interface 306 between the first substrate 902 and the first object part 900 did not fail). The result of the shear test for the second object part 904 is illustrated in FIG. 10 where, upon failure, the failure occurred below the interface 306 and within the substrate 906, which is also indicative of a suitably firm attachment at the interface 306 (i.e., the interface 306 between the second substrate 906 and the second object part 904 did not fail).

### Example 2

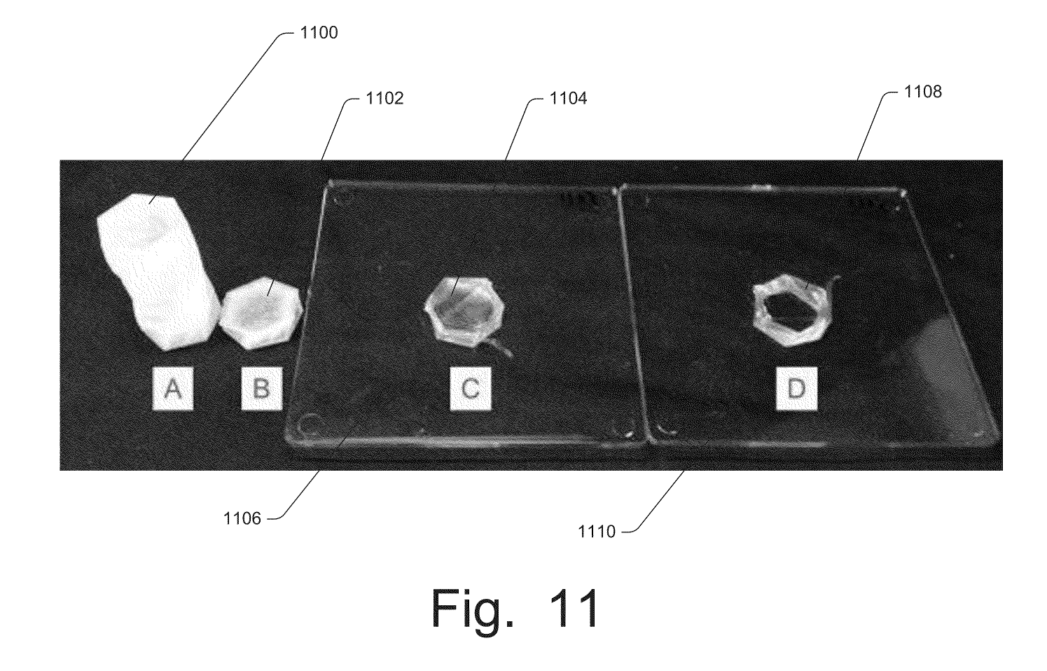

FIG. 11 shows a first hexagonal vase 1100 formed using an additive manufacturing process, a second, shorter hexagonal vase 1102 formed using the additive manufacturing process, the third hexagonal vase 1104 that was formed on a first substrate 1106, and a fourth hexagonal vase 1108 that was formed on a second substrate 1110, but without a bottom to the fourth hexagonal vase 1108. All four hexagonal vases 1100, 1102, 1104, and 1108 were formed with a copolyester build material of the brand name EASTAR™ (specifically EASTAR™ 5011 PETG copolyester), which is a glycol-modified polyethylene terephthalate copolyester commercially available from Eastman Chemical Company®. Furthermore, the hexagonal vases 1100, 1102, 1104, and 1108 were formed with an Ultimaker® 3D printer, with settings at 240° C. for the temperature of the build material (i.e., the EASTAR™ 5011 PETG copolyester) in the extrusion head 108.

The first hexagonal vase 1100 is about 43 mm in height and 22 mm in diameter with a wall thickness of about 1 mm. The frosted (opaque) appearance on the first hexagonal vase 1100 is typical for a 3D printed part made from EASTAR™ 5011 PETG copolyester. The second hexagonal vase 1102 is a truncated version of the first hexagonal vase 1100, measuring approximately 7 mm in height. The second hexagonal vase 1102 is inverted in FIG. 11 to show the bottom as having the frosted (opaque) appearance resulting from the EASTAR™ 5011 PETG copolyester being deposited by the Ultimaker® 3D printer to form the bottom of the second hexagonal vase 1102.

The third hexagonal vase 1104 was printed on the first substrate 1106. The first substrate 1106 was formed by injection molding the same EASTAR™ 5011 PETG copolyester in the shape of the first substrate 1106. As shown in FIG. 11, the bottom of the third hexagonal vase 1104 is less frosted, but not perfectly clear. The fourth hexagonal vase 1108 was printed on the second substrate 1110. The second substrate 1110 is an injection molded substrate, made of EASTAR™ 5011 PETG copolyester (the same as the first substrate 1106). The difference between the third and fourth hexagonal vases 1104 and 1108 is that only the side walls of the fourth hexagonal vase 1108 were printed directly onto the surface of the second substrate 1110 (i.e., the bottom of the vase was not printed for the fourth hexagonal vase 1108. In this example, the side walls of the fourth hexagonal vase 1108 exhibit excellent adhesion to the second substrate 1110.

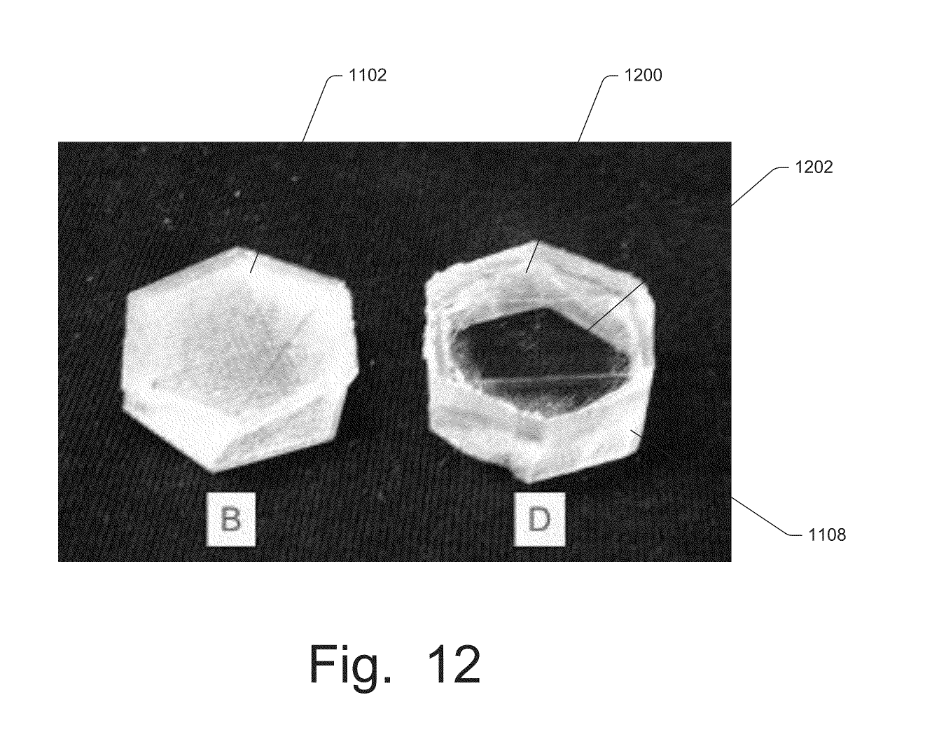

FIG. 12 shows the second hexagonal vase 1102 of FIG. 11 next to a completed object 1200 comprising the fourth hexagonal vase 1108 and a section 1202 of the second substrate 1110 of FIG. 11. The second hexagonal vase 1102 is again inverted in FIG. 11 to show the bottom of the second hexagonal vase 1102 having the frosted (opaque) appearance resulting from the additive manufacturing process. By contrast, the completed object 1200 was created by printing the fourth hexagonal vase 1108 of FIG. 11 (i.e., printing the side walls of the vase without a bottom) directly onto the second substrate 1110, and then the section 1202 was removed from the body of the second substrate 1110 by cutting around the fourth hexagonal vase 1108 with a band saw. As shown in FIG. 12, the clarity of the section 1202 of the second substrate 1110 has been maintained in the completed object 100. While the completed object 1200 in this example is a hollow vase with a transparent bottom 1202, the completed object 1200 could just as easily have been the lid of a cosmetic jar or other container.

Table 1 shows results of haze values recorded for the bottom of the second hexagonal vase 1102 having the frosted (opaque) appearance (“Object 1” in Table 1), and the bottom (section 1202) of the completed object 1200 (“Object 2” in Table 1) having the transparent appearance. As shown by the results in Table 1, the haze values for the bottom of second hexagonal vase 1102 were lower than the haze values for the bottom (section 1202) of the completed object 1200 (a minimum percent difference being approximately 190.8%).

TABLE 1

| Value No. | Haze Meas. of Object 1 | Haze Meas. of Object 2 |
|---|---|---|
| 1 | 90.7 | 2.13 |
| 2 | 90.7 | 1.92 |
| 3 | 90.6 | 2.06 |

### Example 3

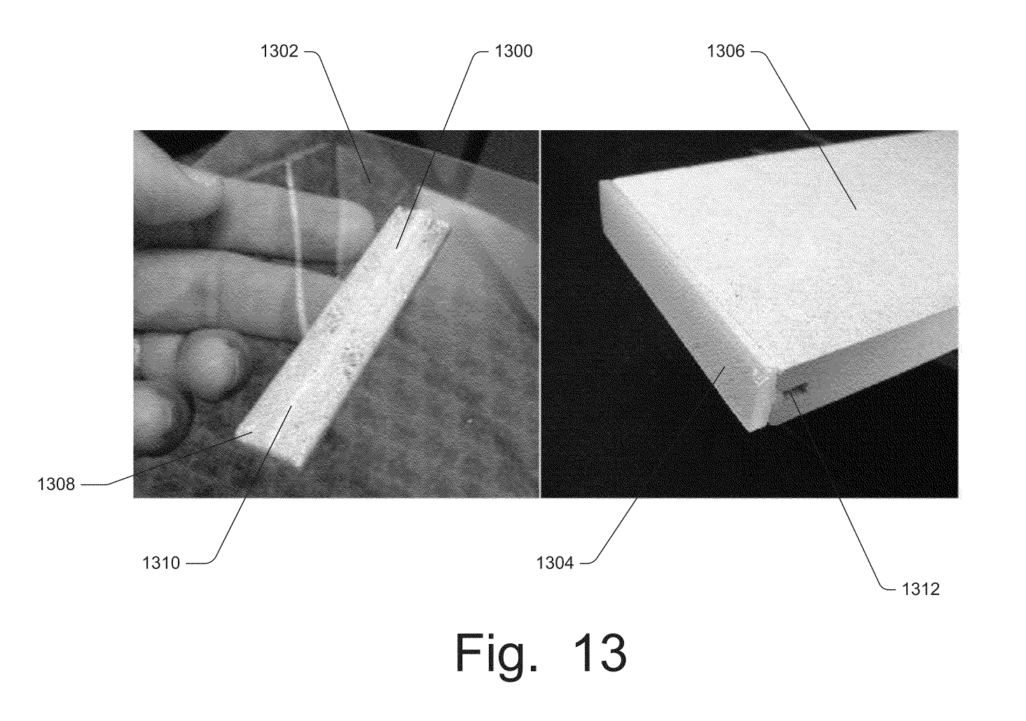

FIG. 13 shows an object part 1300 that was formed on a substrate 1302, and a completed object 1304 comprised of the object part 1300 and a portion of the substrate 1302, wherein the completed object 1304 is shown as being coupled to a board 1306. The photo on the left in FIG. 13 shows the object part 1300 that was printed on the substrate 1302 in the form of a tab 1308 having a raised tongue 1310. The object part 1300 is an example of a functional object part 1300 that provides functionality (fixturing) to the completed object 1304, as shown in the photo on the right in FIG. 13. For example, the raised tongue 1310 is shown to be inserted into a groove 1312 in the board 1306 as an end cap to the board 1306. The build material used to form the object part 1300 is a copolyester build material of the brand name SPECTAR™ (specifically SPECTAR™ 14471 copolyester), which is commercially available from Eastman Chemical Company®. The substrate 1302 measures approximately 2 mm in thickness, and was formed by extruding (i.e., drawing through a die) the same SPECTAR™ 14471 copolyester into the flat, rectangular shape shown in the left photo of FIG. 13. The object part 1300 was formed on the substrate 1302 with an Afinia H-series 3D printer. Settings of the Afinia 3D printer were at 260° C. for the temperature of the build material (i.e., the SPECTAR™ 14471 copolyester) in the extrusion head 108.

The completed object 1304 was created by removing a section of the substrate 1302 from the body of the substrate 1302, and specifically by trimming around the object part 1300 with a band saw. The completed object 1304 was then coupled to the board 1306 by inserting the raised tongue 1310 into the groove 1312 at the end of the board 1306. In this example, the board 1306 measures 82.6 mm in width by 15.9 mm in thickness, and is a medium-density fibreboard (MDF).

### Example 4

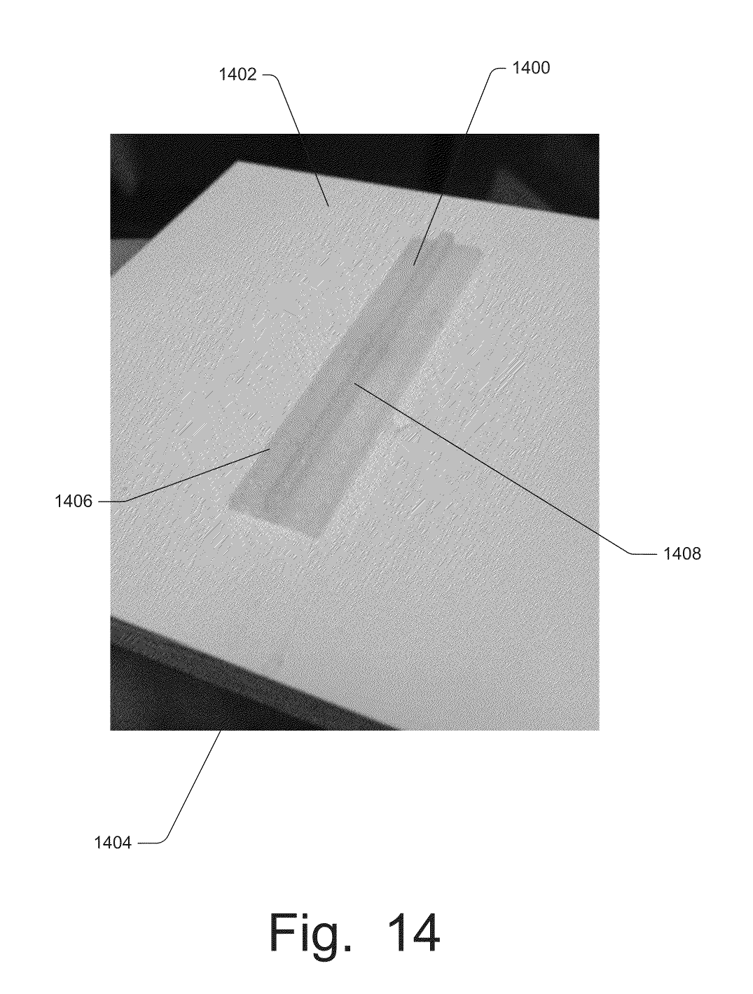

FIG. 14 shows the object part 1400 formed on a substrate 1402 comprised of a board 1404 that was coated with a material that is miscible with the build material of the object part 1400. The object part 1400 is similar to the object part 1300 shown in FIG. 13 in that it is in the form of a tab 1406 having a raised tongue 1408, build material used to form the object part 1400 is the same SPECTAR™ 14471 copolyester, and the object part 1400 was formed on the substrate 1402 with an Afinia H-series 3D printer set at 260° C. for the temperature of the build material (i.e., the SPECTAR™ 14471 copolyester) in the extrusion head 108. The substrate 1402 in this example, however, is comprised of a medium-density fibreboard (MDF) that has been coated with a copolyester called CS10 copolyester, which is commercially available from Eastman Chemical Company®. The CS10 copolyester is miscible with the SPECTAR™ 14471 copolyester even though the CS10 copolyester differs in some properties (e.g., the CS10 copolyester contains additives such as titanium dioxide, calcium carbonate, and other additives). That is, the SPECTAR™ 14471 copolyester and the CS10 copolyester have similar Hildebrand solubility parameters (at least within 5% of each other). In this example, a firm bond was created at the interface 306 between the object part 1400 and the substrate 1402 so that a completed object may be created that comprises the object part 1400 and at least a section of the substrate 1402, if not the entire substrate 1402.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
removably mounting a preformed substrate to a platform, the preformed substrate having a surface including a first material;
forming one or more layers of a second material on the surface of the preformed substrate by an additive manufacturing process, wherein a Hildebrand solubility parameter of the second material is within about 5% of a Hildebrand solubility parameter of the first material; and
producing an object comprising the preformed substrate and the one or more layers of the second material bonded to the preformed substrate.

2. The method of claim 1, wherein the forming the one or more layers comprises forming the one or more layers of the second material on a portion of the surface of the preformed substrate, wherein the object comprises a section of the preformed substrate, and wherein the producing the object comprises removing the section of the preformed substrate from a remainder of the substrate.

3. The method of claim 2, wherein the removing comprises cutting around a periphery of the section of the preformed substrate with a laser cutter.

4. The method of claim 1, wherein the first material and the second material are thermoplastic.

5. The method of claim 4, wherein the first material includes a first copolyester and the second material includes a second copolyester.

6. The method of claim 4, wherein the haze value of the first material is no greater than about 4.

7. The method of claim 1, wherein the forming the one or more layers of the second material on the surface of the preformed substrate by the additive manufacturing process comprises positioning a heated nozzle of an additive manufacturing system within a predetermined distance from the surface of the preformed substrate, and moving the heated nozzle across the surface of the preformed substrate at a predetermined speed while extruding the second material through the heated nozzle in order to join the first material underneath the heated nozzle at the surface of the preformed substrate upon contacting the second material with the first material.

8. The method of claim 1, wherein the additive manufacturing process forms the one or more layers of the second material according to a pattern that is predetermined by software code.

9. The method of claim 1, wherein the forming one or more layers comprises depositing the second material, layer-by-layer, on the surface of the preformed substrate to form a three-dimensional (3D) printed portion of the object bonded to the preformed substrate, and wherein a strength of a bond at an interface between the preformed substrate and the 3D printed portion is at a level that, upon the 3D printed portion being subjected to a shear force of an amount to cause failure, the failure occurs at a location other than the interface.

10. The method of claim 8, wherein at least about 80% of a cross-sectional surface area of the interface remains bonded.

11. The method of claim 9, wherein at least about 95% of a cross-sectional surface area of the interface remains bonded.

12. The method of claim 9, wherein about 100% of a cross-sectional surface area of the interface remains bonded.

13. A method comprising:
forming one or more layers of a material on a surface of a substrate by an additive manufacturing process to produce an object having a first portion comprised of the one or more layers of the material and a second portion comprised of the substrate, the first portion having a first haze value and the second portion having a second haze value, wherein a percent difference between the first haze value and the second haze value is at least about 165%.

14. The method of claim 13 wherein the forming the one or more layers comprises forming the one or more layers of the material on a portion of the surface of the substrate, and wherein the second portion of the object comprises a section of the substrate, the method further comprising removing the section of the substrate from a body of the substrate.

15. The method of claim 13, wherein the forming the one or more layers of the material on the surface of the substrate is performed via extrusion of the material through a nozzle of a dispenser head.

16. The method of claim 13, wherein the material includes a first thermoplastic polymer and the substrate includes a second thermoplastic polymer.

17. The method of claim 13, wherein the forming the one or more layers comprises forming the one or more layers of the material on a portion of the surface of the substrate, and wherein the second portion of the object comprises a section of the substrate, the method further comprising forming one or more additional layers of the material on an additional portion of the surface of the substrate to produce an additional object having a first portion comprised of the one or more additional layers of the material and a second portion comprised of an additional section of the substrate.

18. The method of claim 17, further comprising removing the section and the additional section from a body of the substrate.

19. The method of claim 13, further comprising placing the substrate on a conveyer, and moving the conveyer to position the substrate underneath a nozzle of a dispenser head that deposits the one or more layers of the material onto the surface of the substrate.

20. The method of claim 13, further comprising applying heat to the material before depositing the material onto the surface of the substrate, the heated material being at a temperature included in a range of about 135° C. to about 360° C.

21. The method of claim 13, further comprising moving a nozzle of a dispenser head of an additive manufacturing system at a speed included in a range of about 20 mm/second to about 300 mm/second to form the one or more layers of the material on the surface of the substrate.

22. The method of claim 13, wherein the forming the one or more layers of the material on the substrate includes positioning a nozzle of a dispenser head of an additive manufacturing system within a predetermined distance included within a range of about 0.02 mm to about 4 mm from the surface of the substrate.

23. An additive manufactured article comprising:
a first portion including a first material, the first material having a first haze value and a first Hildebrand solubility parameter; and
a second portion including a second material, the second material having a second haze value and a second Hildebrand solubility parameter, wherein a percent difference between the first haze value and the second haze value is equal to or greater than about 165%, and wherein the first Hildebrand solubility parameter is within about 5% of the second Hildebrand solubility parameter, wherein the first material or the second material comprises layers on layers of said first or second material, respectively.

24. The article of claim 23, wherein the first Hildebrand solubility parameter is substantially the same as the second Hildebrand solubility parameter.

25. The article of claim 23, wherein the first haze value is included in a range of about 0.1 to about 6 and the second haze value is included in a range of about 65 to about 95.

26. The article of claim 23, wherein the first material includes a first thermoplastic polymer and the second material includes a second thermoplastic polymer.

27. The article of claim 23, wherein the first material is a first color and the second material is a second color.
